(19) United States
(12) Patent Application Publication
(10) Pub. No.: US 2024/0083557 A1
(43) Pub. Date: Mar. 14, 2024

(54) A SYSTEM FOR MOTION DAMPING OF A FLOATING MARINE STRUCTURE, AN ARRANGEMENT, A METHOD AND USE OF SUCH SYSTEM

(71) Applicant: North Innovation AS, Åseral (NO)

(72) Inventor: Cay REIERSDAL, Åseral (NO)

(73) Assignee: North Innovation AS, Åseral (NO)

(21) Appl. No.: 18/270,565

(22) PCT Filed: Dec. 21, 2021
(86) PCT No.: PCT/NO2021/050277

§ 371 Date: Jun. 30, 2023

(30) Foreign Application Priority Data
Jan. 4, 2021 (NO) 20210005

(51) Int. Cl. B63B 39/06; F03D 13/25

(52) U.S. Cl. CPC B63B 39/06; F03D 13/256; B63B 2035/442

(57) ABSTRACT

A system, an arrangement and a method, all for motion damping of a floating marine structure. Also disclosed is a use of the system. The system has at least one dampening device configured to dampen a movement in one direction and allowing a movement in the opposite direction, and a suspension arrangement has a respective wire configured to suspend the at least one dampening device hanging at a suspended depth in the water from the marine structure and with the dampening device oriented so that a dampening force induced by the dampening device is subjected in the extension of the wire. Also, each dampening device is a passive damping device has a valve structure configured to dampen a movement in one direction and allowing a movement in the opposite direction essentially without damping interaction.

### CROSS-REFERENCE TO RELATED APPLICATIONS

This application is the U.S. national stage application of International Application PCT/NO2021/050277, filed Dec. 21, 2021, which international application was published on Jul. 7, 2022, as International Publication WO 2022/146142 in the English language. The International Application claims priority of Norwegian Patent Application No. 20210005, filed Jan. 4, 2021. The international application and Norwegian application are both incorporated herein by reference, in entirety.

### FIELD

The present invention relates to a system, an arrangement and a method for motion damping of a floating marine structure. The present invention also relates to a use of a system for motion damping of a floating marine structure.

### BACKGROUND

Prior art systems for motion damping of floating marine structures are used for holding the marine structure relative stable despite subjected to waves and winds. For example, by reducing tilt and pitch movement of a marine wind power plant, the efficiency of generated electric power is increased.

A problem with prior art systems for motion damping of floating marine structures is that in case of extraordinary hard weather conditions, the dampening devices of the system and the system in general are subjected to high stress that may result in permanent failure of the system. It has proven to be difficult to provide a system that can withstand such extraordinary hard weather conditions.

The invention will now be disclosed and has for its object to remedy or to reduce at least one of the drawbacks of the known prior art, or at least provide a useful alternative to the known prior art. In particular, an object of the invention is to provide a system for motion damping of a floating marine structure with improved resistance to extraordinary hard weather conditions. The object is achieved through features, which are specified in the description below and in the claims that follow. The invention is defined by the independent patent claims, and the dependent claims define advantageous embodiments of the invention.

According to an aspect of the invention, there is provided a system for motion damping of a floating marine structure. The system comprises:
at least one dampening device configured to dampen a movement in one direction and allowing a movement in the opposite direction essentially without damping interaction, and
a suspension arrangement comprising a respective wire configured to suspend the at least one dampening device hanging at a suspended depth in the water from the marine structure and with the at least one dampening device oriented so that a dampening force induced by the least one dampening device is subjected in the extension of the wire. Also, each dampening device is a passive damping device comprising a valve structure configured to dampen a movement in one direction and allowing a movement in the opposite direction essentially without damping interaction, wherein the valve structure configuration is provided by slits configured to obstruct water from passing in one direction and essentially letting water pass in the other direction.

The at least one dampening device achieves the function of a check valve, i.e. the dampening device is dampening a movement in one direction by preventing or essentially preventing water from passing through the dampening device and allowing a movement in the opposite direction essentially without damping interaction by allowing water to pass through the dampening device. Also, the passive damping device has the advantage of being functional without being controlled.

The suspension arrangement of the system is configured to suspending the at least one dampening device from the floating marine structure into the water by means of wires and with the at least one dampening device connected so that the induced dampening force is subjected in the extension of the wire, thereby movement of the floating marine structure is dampened. The system assures that the floating marine structure is maintained in relatively stable situation when it is subjected to waves and winds.

The suspension arrangement may comprise a wire control arrangement configured to control the suspended depth of the at least one dampening device in the water. The force subjected to the at least one dampening device is dependent on the depth of the dampening device in the water. At a higher depth, the interaction of waves and turbulent movement of water is less than if the dampening device is positioned closer to the surface of the water. Thereby, the induced damping force by the at least one dampening device is higher at position of higher depth compared to position closer to the surface of the water. However, correspondingly, the stress subjected to the at least one dampening device is also higher at position of higher depth compared to position closer to the surface of the water. By regulating the depth of the at least one dampening device by means of the wire control arrangement, the forces and stress subjected to the system can be reduced by raising the at least one dampening device in case of situations with extraordinary hard weather conditions. The system thereby provides a system for motion damping of a floating marine structure where less forces and stress are subjected to the system in case of extraordinary hard weather conditions.

According to an embodiment of the invention, the suspension arrangement comprises a control unit configured to receive information on a movement of the marine structure and in dependency of said information control the suspended depth of the at least one dampening device in the water by means of the wire control arrangement.

The control unit is configured to receive information on a movement of the marine structure and based on the information determine a desirable depth of the at least one dampening device. Based on the determined desired desirable depth of the at least one dampening device, the control unit is configured to send control information to the wire control arrangement.

The control unit comprises for example computing means, such as a Central Processing Unit (CPU). The control unit further comprises means for receiving the information on the movement of the marine structure, such as sensor information from a movement sensor, and means for generating control information for controlling the suspended depth in the water of the at least one dampening device.

According to an embodiment of the invention, the suspension arrangement comprises at least an upper position and a lower position of the at least one dampening device, wherein the control unit is configured to determine the at least upper position and lower position based on information on the movement of the marine structure and send control information to the wire control arrangement based on the determined at least upper position or lower position.

According to an embodiment of the invention, the control unit is configured to deter-mine the at least upper position and the lower position so that a stress subjected to the system is not exceeding a threshold value. The threshold value relates to a stress that the system is configured to withstand.

According to an embodiment of the invention, the control unit is configured to continuous determine the at least upper position and lower position.

According to an embodiment of the invention, the control unit is configured to intermittent intervals determine the at least upper position and lower position.

According to an embodiment of the invention, the wire control arrangement comprises a respective remotely controllable winch for the at least one dampening device configured to control said suspended depth of the at least one dampening device in the water, wherein the control unit is configured to send control information to the respective winch based on the information on the movement of the marine structure for setting said suspended depth of the at least one dampening device in the water. The winch is configured to be attached to the marine structure and comprising wire drum to which the wire is winded to or unwound.

According to an embodiment of the invention, the information on the movement of the marine structure comprises information on heave and pitch of the marine structure, wherein the control unit is configured to determine the at least upper position and lower position based on a function of heave and pitch of the marine structure information.

According to an embodiment of the invention, the information on the movement of the marine structure further comprises information on surge, sway, roll and yaw, wherein the control unit is configured to determine the at least upper position and lower position based on a function of heave and pitch of the marine structure together with at least one of information on surge, sway, roll and yaw of the marine structure.

According to an embodiment of the invention, the suspension arrangement comprises a motion sensor at or in vicinity of the marine structure configured to provide said motion information to the control unit, wherein the control unit is configured to determine a desired suspended depth of the at least one dampening device based on said motion information.

According to an embodiment of the invention, the motion sensor is one of an angular rate sensor and a gyroscope.

According to an embodiment of the invention, the suspension arrangement comprises continuous positions between the at least upper position and lower position of the at least one dampening device, wherein the control unit is configured to determine any position between and including the upper position and the lower position of the at least one dampening device.

By means of the upper position, the lower position and further positions in-between, the degree of damping is maintained sufficiently high without the stress subjected to the system is exceeding the threshold value. Accordingly, the system enables a high degree of damping to be used that is dependent on the weather condition.

According to an embodiment of the invention, the suspension arrangement comprises a spacer element connected to the marine structure and configured to hold the at least one dampening device at a distance from the marine structure.

According to an embodiment of the invention, the system comprises two or more dampening devices symmetrically arranged around the floating marine structure. The use of a plurality of dampening devices provides an even motion damping of the floating marine structure.

According to an embodiment of the invention, each dampening device comprises a support structure extending in a parabolic surface comprising the valve structure and a plurality of openings.

According to another aspect of the invention, there is provided an arrangement for motion damping of a floating marine structure. The arrangement comprises the floating marine structure and the system according to any of above embodiment attached to the floating marine structure.

According to an embodiment of the invention, the floating marine structure is a spar construction.

According to an embodiment of the invention, the floating marine structure comprises a tower holding a wind turbine.

According to a further aspect of the invention, there is provided a method for motion damping of a floating marine structure with the system according to any of above embodiments. The method comprises:
receiving information on a movement of the marine structure,
determining a suspended depth of the at least one dampening device based on said information, and
setting the at least one dampening device to the determined depth by means of the wire control arrangement.

According to another aspect of the invention, there is provided a use of a system according to any of above embodiments for motion damping of a floating marine structure.

### BRIEF DESCRIPTION OF THE DRAWINGS

Embodiments of the invention will now be described, by way of example only, with reference to the accompanying drawings, in which:

FIG. 1a illustrates a perspective view of an arrangement and a system for motion damping of a floating marine structure according to an embodiment of the invention;

FIG. 1b illustrates a schematic side view of the arrangement and system in FIG. 1a;

FIG. 2a illustrates a perspective view of a dampening device of the arrangement and the system in FIG. 1a, 1b;

FIG. 2b discloses a side view of the dampening device in FIG. 2a; and

FIG. 3 illustrates a flow chart of a method for motion damping of a floating marine structure.

### DETAILED DESCRIPTION OF THE DRAWINGS

The drawings are shown in a schematic and simplified manner, and features that are not necessary for explaining the invention may be left out. Identical reference numerals refer to identical or similar features in the drawings. The various features shown in the drawings may not necessarily be drawn to scale.

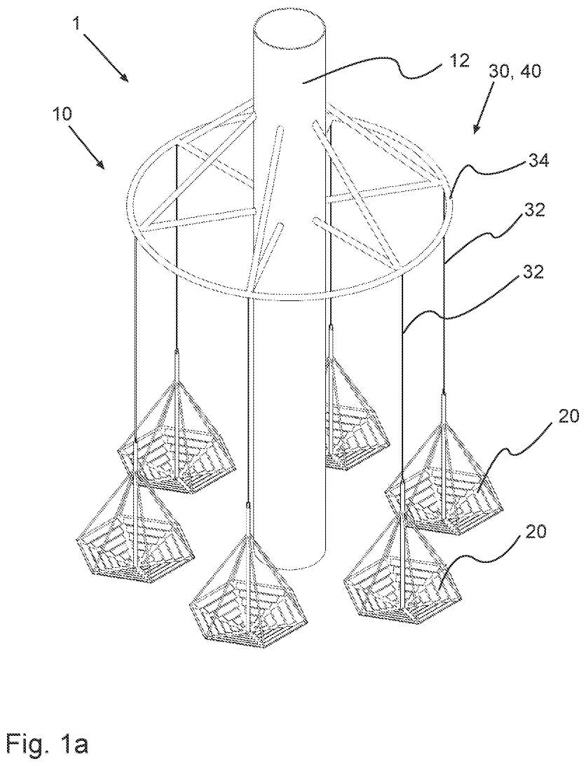

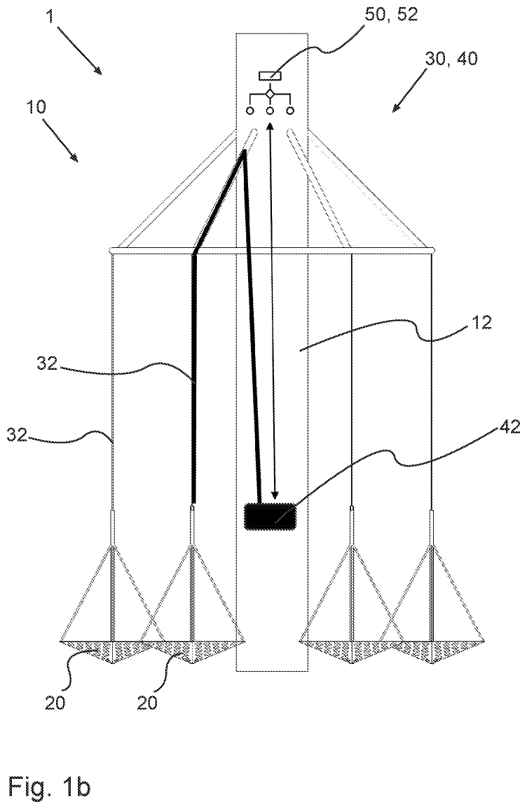

In FIGS. 1a and 1 b is an arrangement 1 and system 10 for motion damping of a floating marine structure 12. The arrangement 1 comprises the floating marine structure 12 and the system 10 attached to the floating marine structure 12.

The floating marine structure 12 comprises for example a tower for holding a wind turbine. In the disclosed embodiment in FIG. 1a, 1b, the floating marine structure 12 comprises a spar construction. However, it shall be understood that the system 10 may be used for motion damping of various types of floating marine structures.

The system 10 is configured to dampen movements of the floating marine structure 12 when subjected to waves and winds. Thereby, the system reduces tilt and pitch movements and the floating marine structure 12 is maintained in a relative stable upright position, which for example is advantageous for the efficiency of generated electric power of a wind power plant.

The system 10 comprises at least one dampening device 20, such as a passive damping device, configured to dampen a movement in one direction and allowing a movement in the opposite direction essentially without damping interaction. In the disclosed embodiment, six damping devices 20 are symmetrically arranged around the floating marine structure 12. By arranging a plurality of damping devices 20 symmetrically around the floating marine structure 12, the motion damping is evenly distributed to the floating marine structure 12.

It shall be understood that any number of dampening devices 20 are applicable. However, in the continued explanation of the invention, the dampening devices 20 will be discussed in plural.

The system 10 further comprises a suspension arrangement 30 for suspending the dampening devices 20 into the water. The suspension arrangement 30 comprises respective wires 32 and a spacer element 34 for holding the dampening devices 20 suspended spaced apart from the floating marine structure 12. The wires are for example steel wires configured for marine use. In the disclosed embodiment, the spacer element 34 comprises a ring formed element attached to the floating marine structure 12.

The dampening devices 20 are attached to end portions of the respective wire 32 so that a dampening force is induced in the extension of the wire 32. Accordingly, a movement in direction upwards will be dampened while movements in direction downwards will be essentially without interaction of the dampening devices 20. Thereby, the system 10 will improve the stability of the floating marine structure 12.

The suspension arrangement 30 further comprises a wire control arrangement 40 configured to control the suspended depth of the dampening devices 20 in the water between at least an upper position and a lower position. Preferably, the wire control arrangement 40 is configured to set the dampening devices 20 to the upper position, the lower position and positions between the upper position and the lower position.

The wire control arrangement 40 comprises for example a respective remotely controllable winch 42 for the dampening devices 20 configured to control the suspended depth of the dampening device 20 in the water.

The suspension arrangement 30 further comprises a control unit 50 and a motion sensor 52 at the marine structure 12 configured to provide motion information to the control unit 50. The control unit 50 is configured, based on the motion information, to determine a desired suspended depth of the dampening devices 20. In the disclosed embodiment, the control unit 50 and the motion sensor 52 are arranged in vicinity of each other. However, it should be understood that the control unit 50 and the motion sensor 52 may be arranged at different locations. The motion sensor 52 is configured to transfer sensor information to the control unit 50.

The motion sensor 52 is configured to sense heave and pitch of the floating marine structure 12 or entities dependent thereon. Preferably, the motion sensor 52 is further configured to sense surge, sway, roll and yaw of the floating marine structure 12 or entities dependent thereon. The motion sensor 52 is for example an angular rate sensor or a gyroscope.

The force subjected to the dampening devices 20 is dependent on the depth suspended in the water. At a higher depth, the interaction of waves and turbulent movement of water is less than closer to the surface. Accordingly, the dampening devices 20 will provide a higher degree of damping when positioned at higher depth compared to a position closer to the surface. However, correspondingly, at higher depth of the dampening devices 20, the stress subjected to the system 10 will also be higher compared to if the dampening devices 20 are arranged closer to the surface.

According to an embodiment of the invention, the control unit 50 is configured to determine a desirable suspended depth of the dampening devices 12 in the water based on the motion information so that the stress subjected to the system 10 is not exceeding a threshold value. The threshold value corresponds for example to a designed acceptable stress level subjected to the system 10. Based on the determined desirable suspended depth of the dampening devices 12, the control unit 50 generates control information to the wire control arrangement 40.

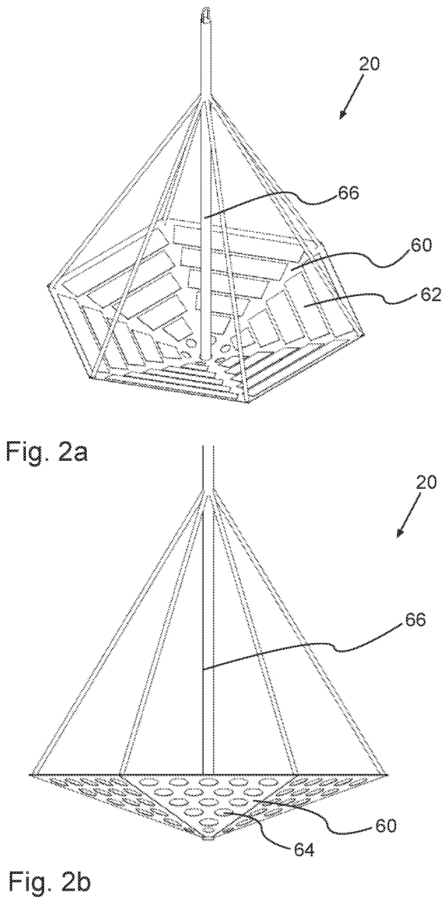

FIGS. 2a and 2b show an example of a dampening device 20 of the arrangement 1 and system 10 in FIG. 1a, 1b. The dampening device 20 is a passive dampening device and has the function of a check valve.

The dampening device 20 comprises a support structure 60, extending in a parabolic surface that comprises a valve structure 62 and a plurality of openings 64. The valve structure 62 is provided with slits configured to obstruct water from passing in one direction and essentially letting water pass in the other direction. The support structure 60 further comprises a shaft 66 configured to be attached to the respective wires 32 of the system 10.

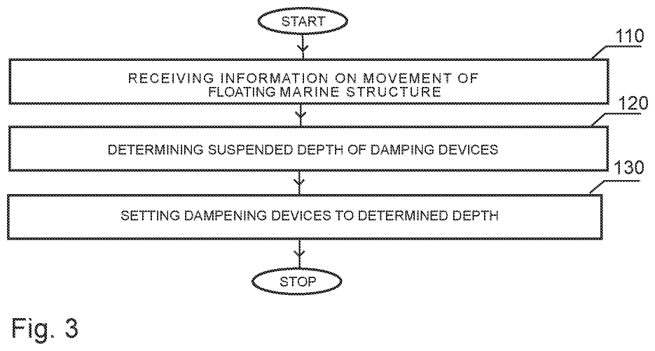

FIG. 3 discloses a flow chart of a method for motion damping of a floating marine structure 12.

The method comprises, in a step 110, receiving information on a movement of the floating marine structure 12. The information is for example generated by the motion sensor 52 and received by the control unit 50.

In a step 120, the method comprises determining a desired suspended depth of the dampening devices 20 based on the received information. The information is for example heave and pitch of the floating marine structure 12. The information may alternatively comprise information on surge, sway, roll and yaw of the floating marine structure 12.

In a step 130, the method comprises setting the dampening device 20 to the determined depth by means of the wire control arrangement 40. The steps of the method are configured to be continuously iterated.

Generally, the terms used in this description and claims are interpreted according to their ordinary meaning the technical field, unless explicitly defined otherwise. Notwithstanding, the terms “comprises” and “comprising” and variations thereof mean that the specified features, steps or integers are included. These terms are not interpreted to exclude the presence of other features, steps or integers. Furthermore, the indefinite article “a” or “an” is interpreted openly as introducing at least one instance of an entity, unless explicitly stated otherwise. An entity introduced by an indefinite article is not excluded from being interpreted as a plurality of the entity.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the embodiments described above, many equivalent modifications and variations will be apparent to those skilled in the art when given this disclosure. Accordingly, the embodiments of the invention set forth above are considered to be illustrative and not limiting. Various changes to the described embodiments may be made without departing from the scope of the invention as defined in the appended claims.

1. A system for motion damping of a floating marine structure, the system comprising:
at least one dampening device configured to dampen a movement in one direction and allowing a movement in the opposite direction essentially without damping interaction, and
a suspension arrangement comprising a respective wire configured to suspend the at least one dampening device hanging at a suspended depth in the water from the marine structure and with the at least one dampening device oriented so that a dampening force induced by the least one dampening device is subjected in the extension of the wire,
wherein each dampening device is a passive damping device comprising a valve structure configured to dampen a movement in one direction and allowing a movement in the opposite direction essentially without damping interaction, wherein the valve structure configuration is provided by slits configured to obstruct water from passing in one direction and essentially letting water pass in the other direction.

2. The system according to claim 1, wherein the suspension arrangement comprises a wire control arrangement configured to control said suspended depth of the at least one dampening device in the water.

3. The system according to any of claim 1, wherein the suspension arrangement comprises a control unit configured to receive information on a movement of the marine structure, determine a desirable depth of the at least one dampening device, and, based on the determined desirable depth, send control information to the wire control arrangement such that the suspended depth of the at least one dampening device in the water is controlled by means of the wire control arrangement.

4. The system according to claim 3, wherein the suspension arrangement comprises at least an upper position and a lower position of the at least one dampening device, wherein the control unit is configured to determine the at least upper position and lower position based on information on the movement of the marine structure and send control information to the wire control arrangement based on the determined at least upper position or lower position.

5. The system according to claim 4, wherein the control unit is configured to determine the at least upper position and the lower position so that a stress subjected to the system is not exceeding a threshold value.

6. The system according to claim 4, wherein the control unit is configured to continuously determine the at least upper position and lower position.

7. The system according to claim 3, wherein the wire control arrangement comprises a respective remotely controllable winch for the at least one dampening device configured to control said suspended depth of the at least one dampening device in the water, wherein the control unit is configured to send control information to the respective winch based on the information on the movement of the marine structure for setting said suspended depth of the at least one dampening device in the water, wherein the winch is configured to be attached to the marine structure, the winch comprising a wire drum to which the wire is winded to or unwound.

8. The system according to claim 3, wherein the information on the movement of the marine structure comprises information on heave and pitch of the marine structure, wherein the control unit is configured to determine the at least upper position and lower position based on a function of heave and pitch of the marine structure information.

9. The system according to claim 3, wherein the information on the movement of the marine structure further comprises information on surge, sway, roll and yaw, wherein the control unit is configured to determine the at least upper position and lower position based on a function of heave and pitch of the marine structure together with at least one of information on surge, sway, roll and yaw of the marine structure.

10. The system according to claim 3, wherein the suspension arrangement comprises a motion sensor at the marine structure configured to provide said motion information to the control unit, wherein the control unit is configured to determine a desired suspended depth of the at least one dampening device based on said motion information.

11. The system according to claim 10, wherein the motion sensor is one of an angular rate sensor and a gyroscope.

12. The system according to claim 3, wherein the suspension arrangement comprises continuous positions between the at least upper position and lower position of the at least one dampening device, wherein the control unit is configured to determine any position between and including the upper position and the lower position of the at least one dampening device.

13. The system according to claim 1, wherein the suspension arrangement comprises a spacer element connected to the marine structure and configured to hold the at least one dampening device at a distance from the floating marine structure.

14. The system according to claim 1, wherein the system comprises two or more dampening devices symmetrically arranged around the floating marine structure.

15. The system according to claim 1, wherein each dampening device comprises a support structure extending in a parabolic surface comprising the valve structure and a plurality of openings.

16. An arrangement for motion damping of a floating marine structure and a system according to claim 1 attached to the floating marine structure.

17. The arrangement according to claim 16, wherein the floating marine structure is a spar construction.

18. The arrangement according to claim 16, wherein the floating marine structure comprises a tower holding a wind turbine.

19. A method for motion damping of a floating marine structure by means of a system according to claim 1, wherein the method comprises:
receiving information on a movement of the marine structure,
determining a suspended depth of the at least one dampening device based on said information, and
setting the at least one dampening device to the determined depth by means of the wire control arrangement.

20. Use of a system according to claim 1, for motion damping of a floating marine structure.
